(19) United States
(12) Patent Application Publication
(10) Pub. No.: US 2008/0179499 A1
(43) Pub. Date: Jul. 31, 2008

(54) Logarithmic response digital pixel sensor and method of processing digital signal thereof

(75) Inventors: Ming-Chieh Tsou, Hsin-Tien City (TW); Yu-Chen Sung, Hsin-Tien City (TW)

Correspondence Address: ROSENBERG, KLEIN & LEE, 3458 ELLICOTT CENTER DRIVE-SUITE 101, ELLICOTT CITY, MD, 21043, US

(73) Assignee: LITE-ON SEMICONDUCTOR CORPORATION

(21) Appl. No.: 11/699,014

(22) Filed: Jan. 29, 2007

(51) Int. Cl. G01J 1/44

(52) U.S. Cl. 250/214 L

(57) ABSTRACT

A logarithmic response digital pixel sensor comprises a linear light detecting unit, an exponential producer, a counting unit, a comparator and a memory unit. The logarithmic response digital pixel sensor is used for detecting light via the linear light detecting unit for producing a linear analogy detecting signal. The exponential producer is used for providing an exponential reference signal. The comparator is used for comparing the linear analogy detecting signal with the exponential reference signal and outputting a comparison result to the memory unit. The memory unit is used for producing a logarithmic response digital signal by processing the comparison result and a count reference signal provided from the counting unit. Thereby, the present invention improves upon the drawbacks of the traditional logarithmic response analogy image sensor, and simplifies the design of the back image sensor processing circuit.

### BACKGROUND OF THE INVENTION

1. Field of the Invention

The present invention relates to a method of processing a digital signal of logarithmic response image sensor, and more particularly to a CMOS logarithmic response digital pixel sensor and a method of processing digital signals thereof.

2. Description of Related Art

Recently, CMOS image sensors have become commonly used in image detecting applications because they have high Quantum efficiency, low power dissipation, low readout noise, wide dynamic range, and random access ability. CMOS image sensors can also link to the CMOS process to reduce costs, so it has gradually replaced CCDs (Charge coupled devices). In all kinds of CMOS image sensors, a logarithmic response image sensor receives stronger illumination intensity, and has a wide dynamic range (around 120 dB) Compared with linear image sensors (with a dynamic range of around 60 dB) the logarithmic response CMOS image sensors are more suitable for being installed in a device that reads pictures or dynamic images via a photoelectric element, for example, a scanner, a cell phone with an image capturing apparatus, a mini-camera, or a monitor, etc.

Referring to FIG. 1, which shows a circuit diagram of a current amplification logarithmic response CMOS image sensor, the current amplification logarithmic response CMOS image sensor is comprised of NMOS transistors 101,102,103, and a photodiode 104. The current amplification logarithmic response CMOS image sensor connects to the highest voltage via the gate of the NMOS transistor 101. At this time, the voltage difference between the gate and the source of the NMOS transistor 101 forms a logarithm relation with the current on the drain of the NMOS transistor 101. Thereby, the relation between the output voltage Vout and the illumination intensity received by the photodiode 104 is also the logarithm relation, therefore the current amplification logarithmic response CMOS image sensor has a very wide dynamic range, and image contrast is very strong.

However, when reading out the voltage of the current amplification logarithmic response CMOS image sensor, the mismatch between pixels is easily influenced by a process of variation that causes the signals to become irregular because the NMOS transistor 101 must operate in the subthreshold operation area to output the logarithmic response signal, and, moreover, the process of manufacturing the current amplification logarithmic response CMOS image sensor makes the threshold voltage mismatched. Moreover, the current amplification logarithmic response CMOS image sensor lacks an effective method of removing fixed-pattern noise.

Although the current amplification logarithmic response CMOS image sensor is highly sensitive and can rapidly switch speeds, the photocurrent produced by the photodiode 104 receiving a usual range illumination is too small when it passes through the NMOS transistor 101. This causes the output voltage Vout to be limited to a very small voltage difference range (about 0.2 V˜0.5 V). When an analogy/digital converter recognizes a pixel signal, the input voltage range of the current amplification logarithmic response CMOS image sensor is 1V, if it is being converted by an 8 bit analogy/digital converter, the output voltage Vout of the current amplification logarithmic response CMOS image sensor must have 1/256V sensitivity. Therefore, the design of the analogy/digital converter in the back of the current amplification logarithmic response CMOS image sensor for recognizing an output voltage Vout is more complicated and difficult to implement.

### SUMMARY OF THE INVENTION

In view of the foregoing shortcomings of the prior art, the present invention uses a linear analogy detecting circuit to detect light and compare an exponential reference signal with a linear reference signal to implement the function of an logarithmic response digital pixel sensor and solve the problem in the back of an A/D converter.

The present invention provides a logarithmic response digital pixel sensor comprising of a linear light detecting unit, an exponential producer, a counting unit, a comparator, and a memory unit. The logarithmic response digital pixel sensor first uses the linear light detecting unit to detect light and then produces a linear analogy detecting signal. The exponential producer provides an exponential reference signal. The comparator compares the linear analogy detecting signal with the exponential reference signal and outputs a comparison result to the memory unit. The memory unit produces a logarithmic response digital signal by processing the comparison result and a count reference signal provided by the counting unit.

Additionally, an encoder is used for encoding the logarithmic response digital signal, therefore the logarithmic response digital signal can be processed using a different encoding type and stored in the memory unit.

The present invention provides a processing signal method for a logarithmic response digital pixel sensor comprising the steps of: detecting light and producing a linear analogy detecting signal; providing a exponential reference signal and a count reference signal; comparing the linear analogy detecting signal with the exponential reference signal and outputting a comparison result; and finally receiving the comparison result and the count reference signal for producing a logarithmic response digital signal.

To make it easier for our examiner to understand the innovative features and technical content, we use a preferred embodiment together with the attached drawings for the detailed description of the invention, but it should be pointed out that the attached drawings are provided for reference and description but not for limiting the present invention.

### BRIEF DESCRIPTION OF THE DRAWINGS

FIG. 1 is a circuit diagram of a current amplification logarithmic response CMOS image sensor;

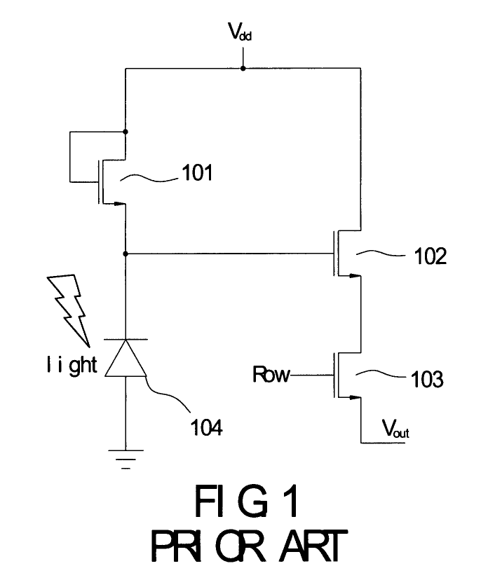

FIG. 2 is a functional block diagram of a logarithmic response digital pixel sensor in accordance with the present invention;

FIG. 3 is a curved diagram of the linear analogy detecting signal and the exponential reference signal;

FIG. 4 is a curved diagram of the logarithmic response digital signal; and

FIG. 5 is a flow chart of a processing signal method of a logarithmic response digital pixel sensor in accordance with the present invention.

### DETAILED DESCRIPTION OF THE PREFERRED EMBODIMENTS

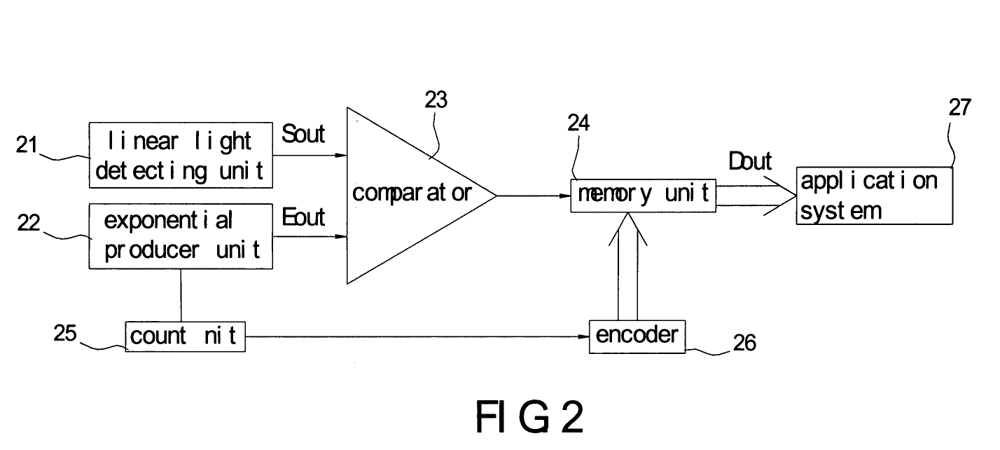

Referring to FIG. 2, which shows a functional block diagram of a logarithmic response digital pixel sensor in accordance with the present invention, the logarithmic response digital pixel sensor comprises a linear light detecting unit 21, an exponential producer 22, a comparator 23, a memory unit 24, a counting unit 25, and an encoder 26. In order to improve upon the drawbacks of the logarithmic response analogy image circuit detecting light signal, the present invention uses the linear light detecting unit 21 to detect a light signal for producing a linear analogy detecting signal Sout. The exponential producer 22 provides an exponential reference signal Eout, the counting unit 25 provides a count reference signal. The linear analogy detecting signal Sout and the exponential reference signal Eout are transmitted to the comparator 23 for comparing, and then the comparator 23 outputs a comparing result to the memory unit 24. The memory unit 24 produces a logarithmic response digital signal Dout, according to the comparing result from the comparator 23 and the count reference signal from the counting unit 25. Furthermore, the logarithmic response digital signal Dout is stored in the memory unit 24 and provides an application system 27 to read and process the signals. Thereby, the design of the analogy/digital converter in the back of the image sensor is uncomplicated and easily to implement.

The encoder 26 is installed between the counting unit 25 and the memory unit 24, and encodes the logarithmic response digital signal Dout to a required code, and then stores the encoded logarithmic response digital signal Dout in the memory unit 24 for the application system 27 to read and process.

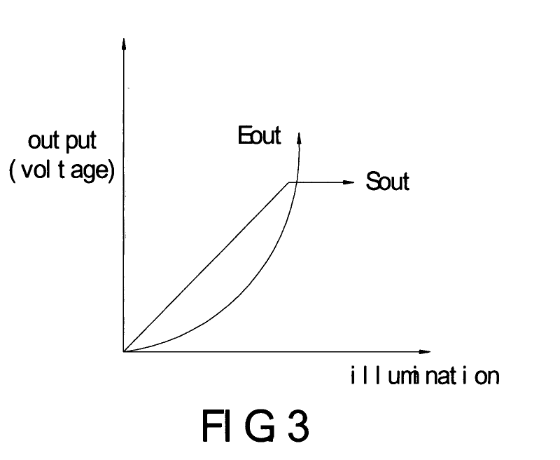

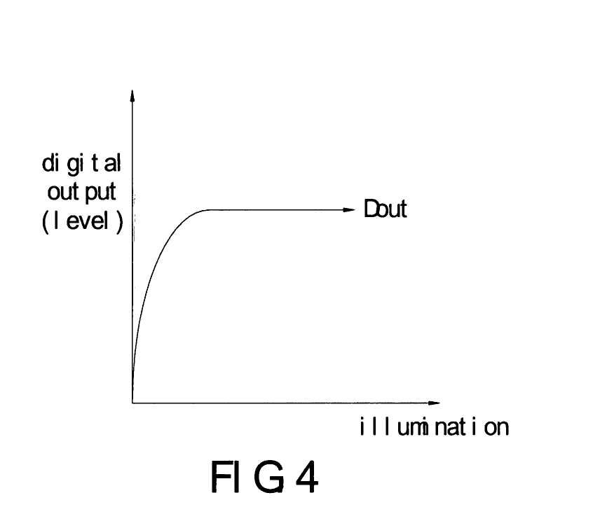

Referring to FIG. 3, a curved diagram of the linear analogy detecting signal and the exponential reference signal, the illumination-output voltage curve of the linear analogy detecting signal Sout and the exponential reference signal Eout is shown. The linear analogy detecting signal Sout and the exponential reference signal Eout are inputted to the comparator 23. The comparator 23 then outputs a comparing result to the memory unit 24 for producing the digital logarithmic curve as shown in FIG. 4, a curved diagram of the logarithmic response digital signal. The logarithmic response digital pixel sensor of present invention thereby implements the digital signal output and the logarithmic response output, and improves upon the shortcomings of the prior art.

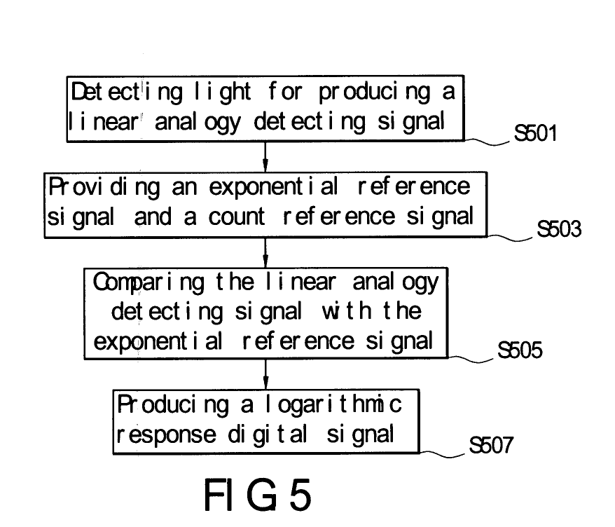

Please refer to FIG. 5, which is a flow chart of a processing signal method for a logarithmic response digital pixel sensor in accordance with the present invention. The linear light detecting unit 21 first detects light for producing a linear analogy detecting signal (shown in FIG. 5 as S501). Next, the exponential producer 22 provides an exponential reference signal for comparison with the linear analogy detecting signal, and the counting unit 25 provides a count reference signal to the memory unit 24 (shown in FIG. 5 as S503). Next, the comparator 23 compares the linear analogy detecting signal with the exponential reference signal and provides a comparing result to the memory unit 24 (shown in FIG. 5 as S505). Finally, the memory unit 24 produces a logarithmic response digital signal for the application system 27, according to the comparing result outputted from the comparator 23 and the count reference signal provided from the counting unit 25, thereby, the application system 27 can read the logarithmic response digital signal from the memory unit 24 to operate and process (showed as FIG. 5 S507).

In summation of the description above, the present invention using the linear analogy detecting unit to detect light improves upon the drawbacks of the prior art, and achieves the function of the logarithmic response image sensor by comparing the linear analogy detecting signal with the exponential reference signal, so that the design of the analogy/digital converter in the back of the image sensor will be uncomplicated and easily to implement. The signal process of the logarithmic response digital pixel sensor of the present invention has the advantage of low power consumption, fast operating speed and low production costs, so that the logarithmic response digital pixel sensor of the present invention can be integrated into a SOC system easily and with successful results.

Although the present invention has been described with reference to the preferred embodiments thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A logarithmic response digital pixel sensor, comprising:
a linear light detecting unit, used for detecting light and producing a linear analogy detecting signal;
an exponential producer, used for providing an exponential reference signal;
a comparator, used for receiving the linear analogy detecting signal and the exponential reference signal, and outputting the result of comparing the linear analogy detecting signal with the exponential reference signal;
a counting unit, connected to the exponential producer, and providing a count reference signal; and
a memory unit, used for receiving the comparison result outputted from the comparator and the count reference signal for producing a logarithmic response digital signal.

2. The logarithmic response digital pixel sensor as claimed in claim 1, further comprising an encoder installed between the counting unit and the memory unit, used for encoding the logarithmic response digital signal to store the logarithmic response digital signal in the memory unit.

3. A processing signal method of a logarithmic response digital pixel sensor, comprising steps of:
detecting light and producing a linear analogy detecting signal;
providing an exponential reference signal and a count reference signal;
comparing the linear analogy detecting signal with the exponential reference signal and outputting a comparison result; and
receiving the comparison result and the count reference signal for producing a logarithmic response digital signal.

4. The processing signal method of logarithmic response digital pixel sensor as claimed in claim 3, wherein the linear analogy detecting signal is produced from a linear light detecting unit.

5. The processing signal method of logarithmic response digital pixel sensor as claimed in claim 3, wherein the exponential reference signal is produced from an exponential producer.

6. The processing signal method of logarithmic response digital pixel sensor as claimed in claim 3, wherein the count reference signal is provided by a counting unit.

7. The processing signal method of logarithmic response digital pixel sensor as claimed in claim 3, wherein the logarithmic digital signal is produced by a memory unit receiving and processing the comparison result and the count reference signal.
